(19) United States
(12) Patent Application Publication
(10) Pub. No.: US 2025/0175300 A1
(43) Pub. Date: May 29, 2025

(54) Sounding Reference Signal Capacity Enhancement

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Hong HE, San Jose, CA (US); Seyed Ali Akbar FAKOORIAN, San Diego, CA (US); Wei ZENG, Saratoga, CA (US); Yushu ZHANG, Beijing (CN)

(21) Appl. No.: 18/841,714

(22) PCT Filed: Mar. 4, 2022
(86) PCT No.: PCT/CN2022/079320

§ 371 Date: Aug. 27, 2024

(51) Int. Cl. H04L 5/00; H04J 13/00; H04W 52/14

(52) U.S. Cl. CPC H04L 5/0051; H04J 13/004; H04L 5/0012; H04W 52/146

(57) ABSTRACT

A user equipment (UE) is configured to receive a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, apply the TD-OCC to the SRS resources in accordance with the configured parameters and perform uplink (UL) transmissions based on a power control scheme for SRS TD-OCC and a collision handling scheme for SRS TD-OCC.

### TECHNICAL FIELD

The present disclosure generally relates to communication, and in particular, to sounding reference signal capacity enhancement.

### BACKGROUND

In a 5G new radio (NR) network, the sounding reference signal (SRS) is transmitted by a user equipment (UE) in the uplink (UL) and used by the network for purposes including UL channel estimation, UL timing estimation, beam measurement and UE positioning. An SRS resource can be shared by multiple UEs transmitting respective SRS and can be multiplexed (interleaved) in a comb configuration along the frequency domain in the same SRS resource to increase the SRS capacity for a higher density of UEs. Additional features to increase the SRS capacity include SRS repetition and RB-level partial frequency sounding (RPFS).

### SUMMARY

Some exemplary embodiments are related to a processor of a user equipment (UE) that is configured to receive a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, apply the TD-OCC to the SRS resources in accordance with the configured parameters and perform uplink (UL) transmissions based on a power control scheme for SRS TD-OCC and a collision handling scheme for SRS TD-OCC.

Other exemplary embodiments are related to a user equipment (UE) having a transceiver configured to communicate with a network and a processor communicatively coupled to the transceiver and configured to receive a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, apply the TD-OCC to the SRS resources in accordance with the configured parameters and perform uplink (UL) transmissions based on a power control scheme for SRS TD-OCC and a collision handling scheme for SRS TD-OCC.

Still further exemplary embodiments are related to a processor of a base station configured to determine a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, wherein the SRS configuration is applicable to a user equipment (UE) such that multiple UEs can use a same SRS resource and transmit the SRS configuration to the UE.

Additional exemplary embodiments are related to a base station having a transceiver configured to communicate with a user equipment (UE) and a processor communicatively coupled to the transceiver and configured to determine a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, wherein the SRS configuration is applicable to the UE such that multiple UEs can use a same SRS resource and transmit the SRS configuration to the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4a shows an exemplary resource grid comprising SRS symbols prior to the application of a TD-OCC pattern according to various exemplary embodiments.

FIG. 4b shows exemplary TD-OCC patterns with length N_{OCC} of N_{OCC}=4 according to various exemplary embodiments

FIG. 4c shows an exemplary resource grid comprising SRS symbols after the application of a TD-OCC pattern according to various exemplary embodiments.

FIG. 4d shows an exemplary resource grid comprising SRS symbols prior to the application of different TD-OCC patterns within an SRS frequency hopping resource according to various exemplary embodiments.

FIG. 4e shows an exemplary resource grid comprising SRS symbols after the application of different TD-OCC patterns within an SRS frequency hopping location according to various exemplary embodiments.

FIG. 4f shows an exemplary resource grid comprising SRS symbols prior to the application of different TD-OCC patterns across different SRS frequency hopping locations in an SRS resource according to various exemplary embodiments.

FIG. 4g shows an exemplary resource grid comprising SRS symbols after the application of different TD-OCC patterns within different SRS frequency hopping locations in an SRS resource according to various exemplary embodiments.

FIG. 5a shows a plot of a transmit (Tx) power for SRS and UL transmissions that overlap in time with a first power scaling operation applied according to various exemplary embodiments.

FIG. 5b shows a plot of a transmit (Tx) power for SRS and UL transmissions that overlap in time with a second power scaling operation applied according to various exemplary embodiments.

FIG. 5c shows a plot of a transmit (Tx) power for SRS and UL transmissions that overlap in time with a third power scaling operation applied according to various exemplary embodiments.

FIG. 6a shows a plot of collision handling behavior when SRS TD-OCC symbols and other UL signals overlap in time in the same cell according to a first option according to various exemplary embodiments.

FIG. 6b shows a plot of collision handling behavior when SRS TD-OCC symbols and other UL signals overlap in time in the same cell according to a second option according to various exemplary embodiments.

FIG. 7 shows an exemplary SRS Resource IE including parameters for SRS TD-OCC according to various exemplary embodiments according to various exemplary embodiments.

FIG. 8 shows a method for using time domain orthogonal cover code (TD-OCC) for SRS capacity enhancement according to various exemplary embodiments according to various exemplary embodiments.

### DETAILED DESCRIPTION

The exemplary embodiments may be further understood with reference to the following description and the related appended drawings, wherein like elements are provided with the same reference numerals. The exemplary embodiments introduce patterns and techniques for applying time domain orthogonal cover code (TD-OCC) to sounding reference signal (SRS) transmissions to enhance SRS capacity. According to some exemplary embodiments, SRS TD-OCC patterns are described. In other exemplary embodiments, operations for power control and collision handling for SRS TD-OCC are described. In still further exemplary embodiments, the network configuration of the UE for SRS TD-OCC is described.

The exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. Therefore, the UE as described herein is used to represent any electronic component that directly communicates with the network.

The exemplary embodiments are also described with regard to a 5G New Radio (NR) network. However, reference to a 5G NR network is merely provided for illustrative purposes. The exemplary embodiments may be utilized with any network implementing UDC methodologies similar to those described herein. Therefore, the 5G NR network as described herein may represent any type of network implementing similar UDC functionalities as the 5G NR network.

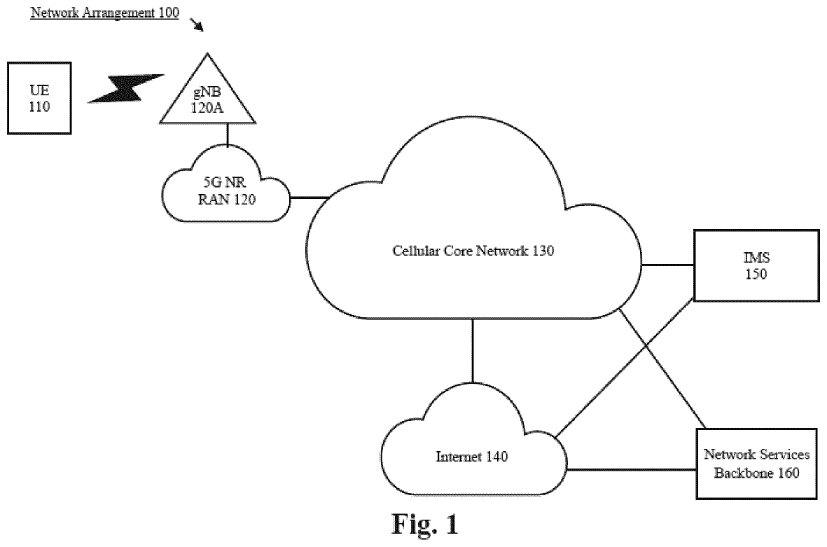

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the qNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

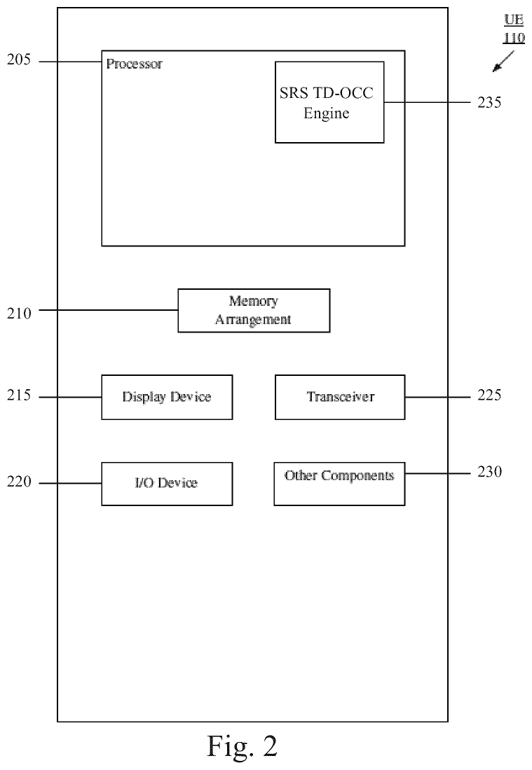

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an SRS TD-OCC engine 235 for performing various operations related to applying TD-OCC to SRS resources. The operations may include receiving TD-OCC parameters in an SRS configuration, the parameters including a length, a pattern and a hopping configuration for TD-OCC, and applying TD-OCC to SRS symbols in accordance with the configured parameters. The SRS TD-OCC engine 235 can additionally perform operations for power scaling and collision handling when TD-OCC SRS transmissions overlap in time with other uplink (UL) transmissions, to be explained in detail below.

The above referenced engine 235 being an application (e.g., a program) executed by the processor 205 is provided merely for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

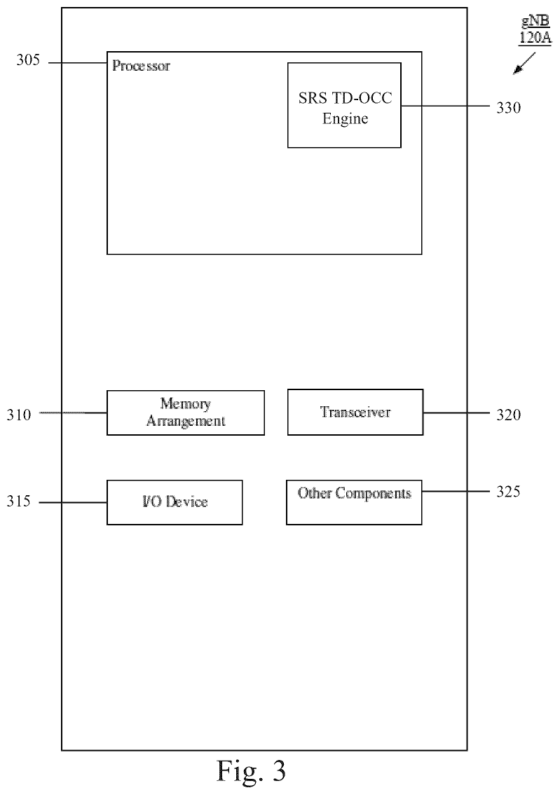

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a SRS TD-OCC engine 330 for performing various operations related to the application of TD-OCC to SRS resources. The operations may include transmitting TD-OCC parameters to the UE in an SRS configuration, the parameters including a length, a pattern and a hopping configuration for TD-OCC, and receiving/decoding SRS symbols with TD-OCC applied thereon in accordance with the configured parameters. The SRS TD-OCC engine 330 can further configure the UE for collision handling behavior, to be explained in detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

NR SRS has been specified for capacity enhancements in prior releases to support a higher density of mobile devices. In Rel-15, NR SRS can be transmitted only in the last 6 symbols of each slot and can be repeated up to 4 symbols using simple repetition without any cover code. NR SRS was further specified in Rel-15 to support Comb 2/4, wherein in a comb2 configuration, two SRS signals can be multiplexed (interleaved), and in a comb4 configuration, four SRS signals can be multiplexed (interleaved) from different UEs across frequency resources on a same symbol. In Rel-16, NR SRS can be transmitted in any symbol and SRS repetition is supported with 8/12 symbols.

In Rel-17, NR SRS coverage and capability is further enhanced. RB-level Partial Frequency Sounding (RPFS) is supported, allowing SRS transmission on partial frequency resources within the legacy SRS frequency resources. In RPFS, start PRB location hopping is supported. SRS repetition is supported with 10/14 symbols and Comb 8 is supported with a maximum of 6 cyclic shifts (CS). In Rel-18 NR, further SRS capacity enhancements may be specified.

According to various exemplary embodiments described herein, Time Domain Orthogonal Cover Code (TD-OCC) is used to enhance SRS capacity when the SRS spans multiple symbols. In one aspect, a pattern for SRS TD-OCC is described. In other aspects, operations for power control and collision handling for SRS TD-OCC are described. In still another aspect, the network configuration of the UE for SRS TD-OCC is described.

In a 5G new radio (NR) network, the SRS is transmitted by a UE in the uplink (UL) and used by the network for purposes including UL channel estimation, UL timing estimation, and UE positioning.

The UE is configured with SRS via RRC signaling. The SRS configuration (SRS-Resource IE) is specified in TS 38.331 clause 6.3.2. The SRS configuration defines respective lists of SRS resources (SRS-Resources), SRS resource sets (SRS-ResourceSets) comprising K≥1 SRS resources, SRS positioning resources (SRS-PosResources) and/or SRS positioning resource sets (SRS-PosResourceSets) comprising K≥1 SRS positioning resources. The term “SRS configuration,” as used herein, may refer to either an SRS resource (or resource set) configuration or an SRS positioning resource (or resource set) configuration, unless indicated otherwise. Those skilled in the art will understand that similar parameter fields are used in both types of SRS configurations. The network can trigger the transmission of the set of aperiodic SRS resources using a configured L1 DCI (aperiodicSRS-ResourceTrigger), activate the transmission of the semi-persistent SRS resource set using MAC-CE, or configure the transmission of the periodic SRS resource set using RRC.

It should be understood that throughout this description specific parameter names and/or information element (IE) names are used as examples. This use of specific names is only exemplary and the information being reported by the parameter or IE may be reported to the network and/or the UE using different parameter or IE names or reported in other manners.

Within the SRS resource configuration, parameters for frequency hopping (freqHopping) can be configured including B_{SRS}/C_{SRS} and bₕₒₚ and a parameter for SRS sequence (sequenceID) can be configured to initialize a pseudo random group and sequence hopping.

Within the SRS resource set configuration, parameters for resource mapping (resourceMapping) can be configured including a parameter Nₛ for a number of OFDM symbols for the SRS resource (nrofSymbols), a parameter for a starting slot (startPosition) and a parameter R (where R∈(1,2,4)) for a number of repetitions (repetitionFactor), wherein R≤Nₛ and, if R is not configured, then R is equal to the number of OFDM symbols Nₛ. The above description applies to Rel-16 NR and more values are allowed to be configured in Rel-17 NR.

When intra-slot frequency hopping within an SRS resource is not configured (R=Nₛ), each of the antenna ports of the SRS resource in each slot is mapped in all the Nₛ symbols to the same set of subcarriers in the same set of PRBs. When intra-slot frequency hopping within an SRS resource is configured without repetition (R=1) according to the SRS hopping parameters, each of the antenna ports of the SRS resource in each slot is mapped to different sets of subcarriers in each OFDM symbol, where the same transmission comb value is assumed for different sets of subcarriers. When both frequency hopping and repetition within an SRS resource in each slot are configured (Nₛ>R), each of the antenna ports of the SRS resource in each slot is mapped to the same set of subcarriers within each pair of R adjacent OFDM symbols, and frequency hopping across the two pairs is according to the SRS hopping parameters.

Orthogonal cover code (OCC) can be used to provide orthogonal multiplexing in the time domain (TD-OCC) or the frequency domain (FD-OCC) and is commonly used for certain types of signals including, e.g., the demodulation reference signal (DMRS). According to various exemplary embodiments described herein, TD-OCC is applied to SRS resources to increase the SRS capacity. The TD-OCC can increase SRS capacity by creating orthogonality across the SRS resource in different ways and allowing a greater number of UEs to use the same resource.

SRS TD-OCC allows orthogonal cover code to be applied to different SRS symbols, spreading the SRS in the time domain. For the i-th RE in the j-th SRS symbol, the actual transmitted RE is SRS {i, j}*TD-OCC j. The design of the TD-OCC code can be binary, e.g., using Hadamard code, or can be complex, e.g., using a DFT (Discrete Fourier Transform) sequence.

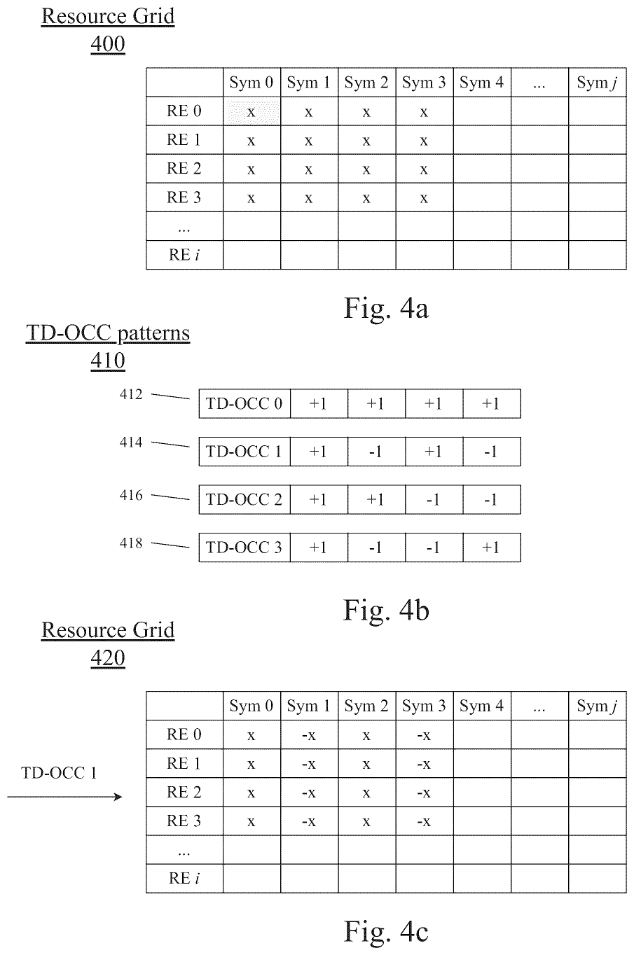

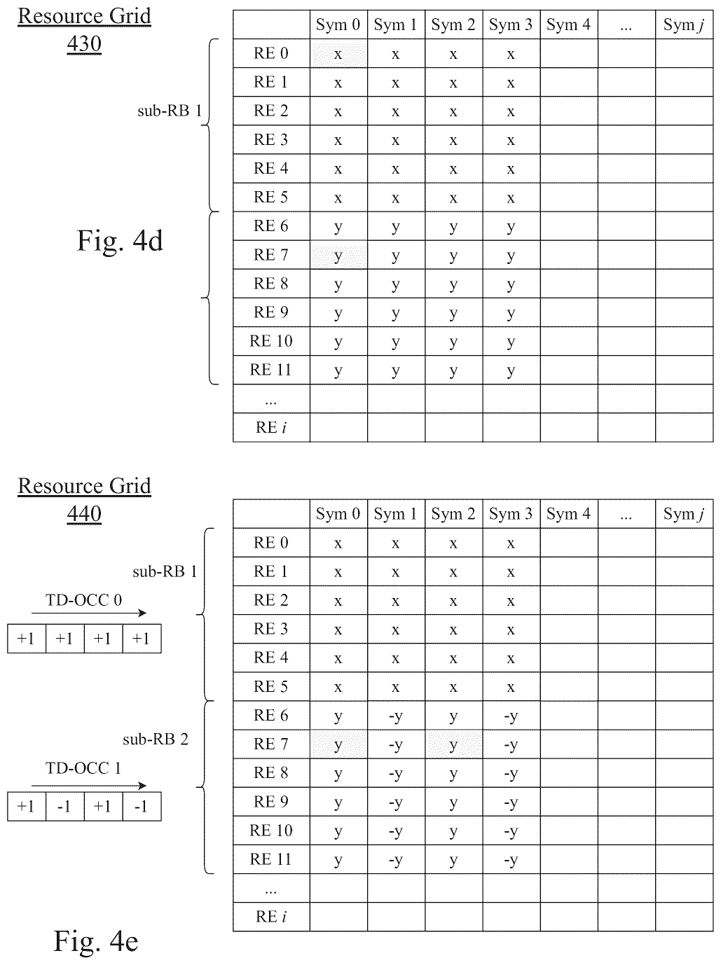

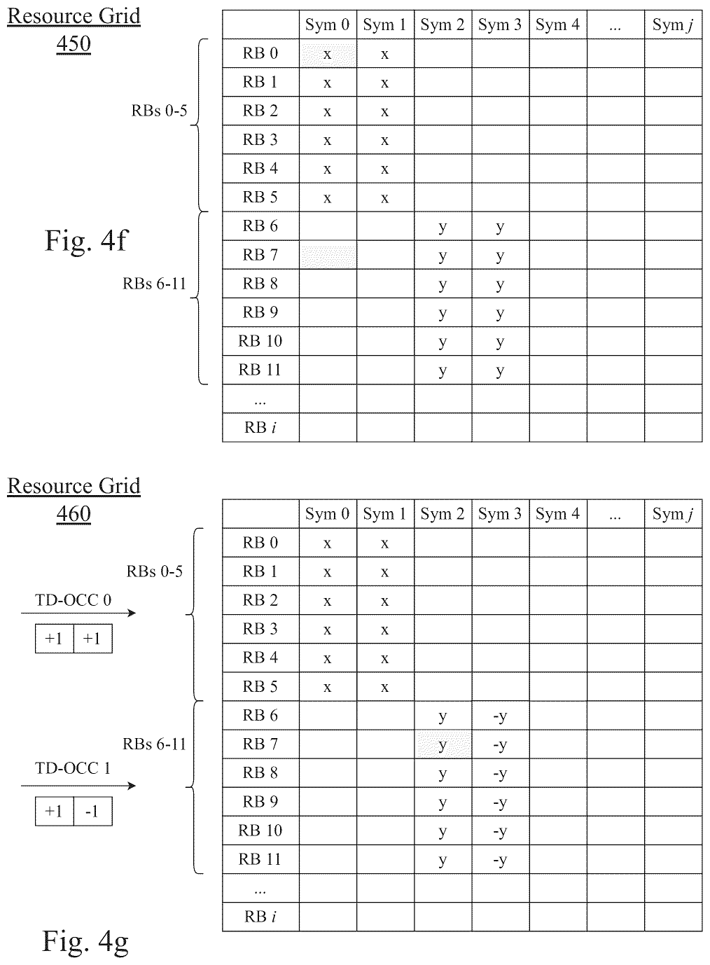

FIG. 4a shows an exemplary resource grid 400 comprising SRS symbols prior to the application of a TD-OCC pattern. In this example, the SRS resource comprises N=4 symbols (Symbols 0-3) and four resource elements (RE) (REs 0-3) and are labeled “x” to represent an SRS sequence.

FIG. 4b shows exemplary TD-OCC patterns 410 with length N_{OCC} of N_{OCC}=4. In some exemplary embodiments, the length N_{OCC} of the TD-OCC code can depend on the number of symbols of the SRS resource. When intra-slot SRS frequency hopping is not configured, N_{OCC} is defined as a factor of the number of symbols for SRS repetition, which, in this scenario, is equal to the number of symbols Nₛ of the SRS resource (parameter nrofSymbols in SRS-Resource or SRS-PosResource of SRS-Config). In other exemplary embodiments, the length N_{OCC} of the TD-OCC code can depend on the number of symbols for intra-slot SRS frequency hopping. When intra-slot SRS frequency hopping is configured (parameter freqHopping), N_{OCC} is defined as a factor of the number of symbols for intra-slot SRS frequency hopping, which, in this scenario, is equal to the repetition factor R (parameter repetitionFactor in SRS-Resource or SRS-PosResource of SRS-Config).

The TD-OCC 0 (412) comprises a first pattern in which each of the REs on symbols 0-3 are transmitted with 0 degree phase rotation. The TD-OCC 1 (414) comprises a second pattern in which REs on symbols 0 and 2 are transmitted with 0 degree phase rotation and REs on symbols 1 and 3 are transmitted with 180 degree phase rotation. The TD-OCC 2 (416) comprises a third pattern in which REs on symbols 0 and 1 are transmitted with 0 degree phase rotation and REs on symbols 2 and 3 are transmitted with 180 degree phase rotation. The TD-OCC 3 (418) comprises a fourth pattern in which REs on symbols 0 and 3 are transmitted with 0 degree phase rotation and REs on symbols 1 and 2 are transmitted with 180 degree phase rotation.

FIG. 4c shows an exemplary resource grid 420 comprising SRS symbols after the application of a TD-OCC pattern. In this example, the TD-OCC 1 414 described in FIG. 4b is applied. The REs on symbols 0 and 2 are transmitted with 0 degree phase rotation (labeled “x” to represent an SRS sequence with no phase rotation) and the symbols 1 and 3 are transmitted with 180 degree phase rotation (labeled “−x” to represent an SRS sequence with 180 degree phase rotation).

In one aspect, for interference randomization, different SRS sequences (configured as sequenceID in the SRS resource configuration) can be used for different SRS repetition symbols and/or different frequency hopping locations (which are defined per SRS-Resource for a given SRS repetition in an SRS-Resource).

When TD-OCC is used to improve the SRS capacity, interference randomization may be used. The following describes two different types of interference randomization. It should be understood that one or both of the types of interference randomization may be used. A first type of interference randomization may be applied within the same SRS frequency hopping where different TD-OCC code can be used for different frequency locations. This may include a first option where every RE or multiple REs within a RB are randomized. In a second option, the randomization is per RB, e.g., every one or multiple RBs. A second type of interference randomization may be applied across different SRS frequency hopping where different TD-OCC code can be used for different frequency locations. The options described above may also be applied to this type of interference randomization.

FIG. 4d shows an exemplary resource grid 430 comprising SRS symbols prior to the application of different TD-OCC patterns within an SRS frequency hopping resource. In this example, the SRS resource comprises N=4 symbols (Symbols 0-3) and 12 resource elements (RE) (REs 0-11), wherein a first sub-resource block (sub-RB) comprises REs 0-5 and a second sub-RB comprises REs 6-11. In the exemplary resource grid 430, REs in the first sub-RB (sub-RB 1) are indicated with an “x” to represent a first SRS sequence and REs in the second sub-RB (sub-RB 2) are indicated with a “y” to represent a second SRS sequence. It should be understood that these denotations of “x” and “y” are used only to illustrate the phase rotation operation of different TD-OCC patterns within an SRS resource, and should not be interpreted as indicating any kind of special status to these SRS resources.

FIG. 4e shows an exemplary resource grid 440 comprising SRS symbols after the application of different TD-OCC patterns within an SRS frequency hopping location. In this example, the TD-OCC pattern 0 (412) is applied to sub-RB 1 and the TD-OCC pattern 1 (414) is applied to sub-RB 2. For sub-RB 1, there is no change. For sub-RB 2, each RE (7-13) on symbols 1 and 3 is transmitted with 180 degree phase rotation.

In a second option, across different SRS frequency hopping locations in an SRS resource, different TD-OCC code can be used.

FIG. 4f shows an exemplary resource grid 450 comprising SRS symbols prior to the application of different TD-OCC patterns across different SRS frequency hopping locations in an SRS resource. In this example, a first SRS frequency hopping comprises N=2 symbols (Symbols 0-1) and 6 resource blocks (RB) (RBs 0-5), wherein each RB comprises 12 RE. A second SRS frequency hopping comprises N=2 symbols (Symbols 2-3) (different from the first SRS frequency hopping) and 6 RBs (RBs 6-11). Similar to the resource grid 430 of FIG. 4d, in the exemplary resource grid 450, RBs in the first frequency hopping location are indicated with an “x” to represent a first SRS sequence and RBs in the second frequency hopping location are indicated with a “y” to represent a second SRS sequence. It should be understood that these denotations of “x” and “y” are used only to illustrate the phase rotation operation of different TD-OCC patterns within an SRS resource, and should not be interpreted as indicating any kind of special status to these SRS resources.

FIG. 4g shows an exemplary resource grid 460 comprising SRS symbols after the application of different TD-OCC patterns within different SRS frequency hopping locations in an SRS resource. In this example, the TD-OCC pattern 0 (412) is applied to the first frequency hopping location (RBs 0-5) (with truncated length N_{OCC}=2) and the TD-OCC pattern 1 (414) is applied to the second frequency hopping location (RBs 6-11) (with truncated length N_{OCC}=2). For the first frequency hopping location, there is no change, e.g., the SRS on RBs 0-5 are transmitted with a phase rotation of 0 degrees. For the second frequency hopping location, RBs 6-11 on symbol 3 are transmitted with 180 degree phase rotation.

With the framework described above, TD-OCC can be applied to SRS symbols to enhance the SRS capacity for the RAN. The RAN can smartly trigger SRS transmissions with TD-OCC applied thereon from a plurality of UEs and multiplex the SRS from the various UEs across the SRS resource with high interference randomization.

In another aspect of these exemplary embodiments, power control aspects for SRS TD-OCC operation are described. To ensure the orthogonality of different OCC, the UE should ensure the SRS is transmitted with phase continuity across all SRS symbols in TD-OCC operation. To do so, the transmit power can be adjusted by the UE for SRS symbols to address phase continuity issues that might otherwise arise, while ensuring that a transmit power remains within specified limits.

In a first embodiment for power control, the UE ensures that, when TD-OCC is used for SRS, all SRS symbols within the OCC operation are transmitted at the same power. In existing operation, the RAN can send power control commands for the UE transmission of SRS symbols on a per-symbol basis. According to some exemplary embodiments, the UE in TD-OCC operation follows power control commands only for the first SRS symbol in an OCC operation. All other power control commands for subsequent SRS symbols in the OCC operation are ignored.

In other exemplary embodiments for power control, the UE implements a power scaling scheme for dual connectivity (DC) and/or carrier aggregation (CA) operation. In DC and/or CA operation, power scaling is used to reduce the UE transmit power that would otherwise exceed specified limits due to simultaneous transmission of other physical layer (PHY) channels.

In a first option, when power scaling is determined to be needed, a first type of power scaling operation may be implemented where the SRS can have the highest priority relative to other UL transmissions. SRS power scaling may be applied after power scaling is applied for all other PHY channels to a predetermined minimum transmit power. In the first option, the SRS can transmit at a power sufficient to ensure phase continuity for the SRS symbols across the TD-OCC. Phase continuity is particularly important for minimizing interference around the cell and difficult to maintain when other PHY channels, e.g., PUSCH overlap with the SRS symbols. In the first option, the UE is allowed to scale down the transmit power of the other channels.

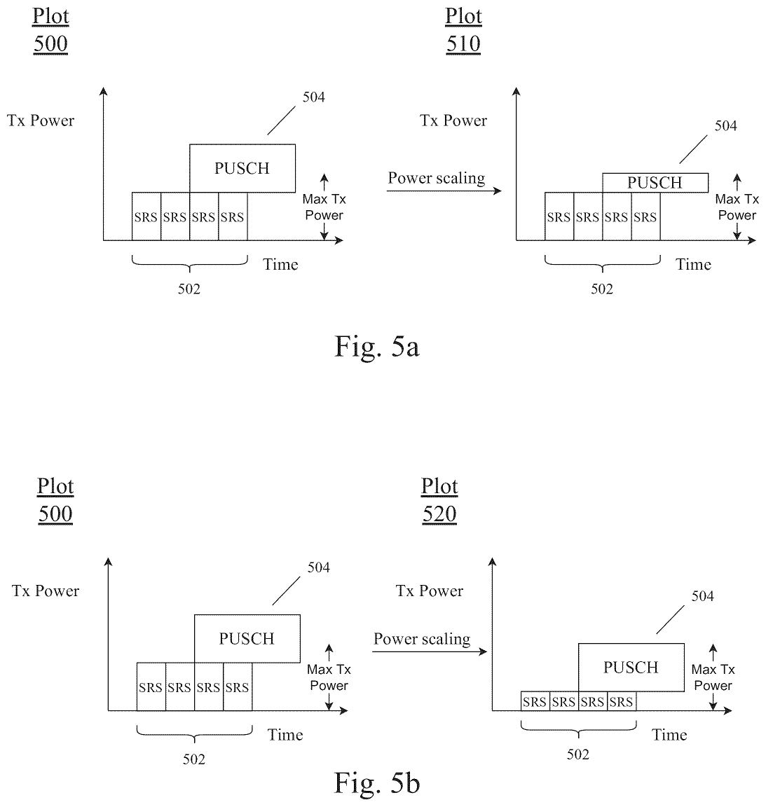

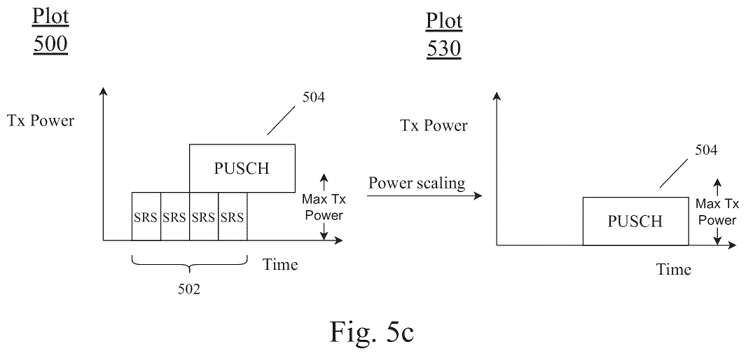

FIG. 5a shows a plot 510 of a transmit (Tx) power for SRS and UL transmissions that overlap in time with a first power scaling operation applied. FIG. 5a shows a first plot 500 of a transmit (Tx) power for SRS and UL transmissions that overlap in time without any power scaling applied. Four SRS symbol transmissions 502 are shown and a PUSCH 504 that overlaps with the last two of the four symbols 502. Although a PUSCH is shown, other UL channels can overlap in time with the SRS resource. As shown, the combined transmit power of the SRS and PUSCH would exceed a maximum specified Tx power without any power scaling operations.

The second plot 510 shows the transmissions using the first power scaling operations as described above. Specifically, the four SRS symbol transmissions 502 are transmitted without any power scaling. The PUSCH 504 that overlaps with the last two of the four symbols 502 is scaled down in Tx power to bring the combined Tx power within specified limits.

In a second option, a second type of power scaling operation may be implemented where the UE can scale down the Tx power for SRS symbols to bring the UL transmit power within specified limits so long as phase continuity is ensured for the SRS symbols. Phase continuity is related to the UE PA (power amplifier) operation, and techniques for maintaining phase continuity are configured based on UE implementation, e.g., could be different for different UE. In one example, power amplifier operations can control how and whether the UE can maintain phase continuity when PA operates at different output powers.

FIG. 5b shows a plot 520 of a transmit (Tx) power for SRS and UL transmissions that overlap in time with a second power scaling operation applied. The first plot 500 is identical to the plot 500 of FIG. 5a. Whereas, the plot 520 shows the transmissions using the second power scaling operations as described above. The PUSCH 504 that overlaps with the last two of the four symbols 502 are transmitted without any power scaling. The four SRS symbol transmissions 502 are scaled down in Tx power to bring the combined Tx power within specified limits, wherein the power scaling of the SRS symbols does not inhibit maintaining phase continuity for the SRS symbols.

In a third option, a third type of power scaling operation may be implemented where the SRS can be dropped when phase continuity cannot be guaranteed.

FIG. 5c shows a plot 530 of a transmit (Tx) power for SRS and UL transmissions that overlap in time with a third power scaling operation applied. Again, the first plot 500 is identical to the plot 500 of FIG. 5a. The plot 530 shows the transmissions using the third power scaling operations as described above. As shown, the four SRS symbols 502 from plot 500 have been dropped. The PUSCH 534 that previously overlapped with the last two of the four symbols 502 is transmitted without any power scaling.

In another aspect of these exemplary embodiments, collision handling aspects for SRS TD-OCC operation are described.

In some exemplary embodiments, when the SRS transmission partially overlaps with the transmission of other PHY channels in the same cell, some or all of the SRS symbols can be dropped. In one option, all of the SRS are dropped when any of the SRS symbols in an OCC operation overlap in time with other PHY symbols. In another option, partial symbols from the OCC operation can be dropped. The symbols overlapping in time with the other PHY transmission are dropped, but if the truncated OCC applied to the remaining SRS symbols still maintains orthogonality, the non-overlapping SRS symbols can be transmitted.

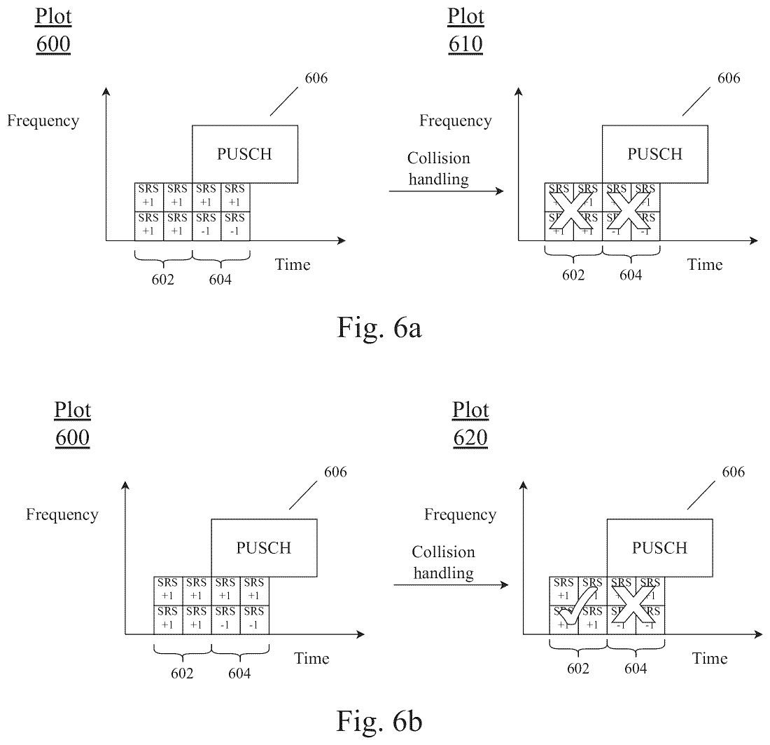

FIG. 6a shows a plot 610 of collision handling behavior when SRS TD-OCC symbols and other UL signals overlap in time in the same cell according to a first option. Initially, FIG. 6a shows a first plot 600 where the SRS resource 602, 604 comprises four symbols in the time domain and two RE in the frequency domain with TD-OCC 0 applied to the SRS symbols. The last two symbols 604 of the SRS resource overlap in time with a PUSCH transmission, while the first two symbols 602 of the SRS resource do not overlap with any UL signals.

The second plot 610 shows the first collision handling operation described above being applied. In this example, because the time overlap exists for the SRS symbols 604 and the PUSCH 606, all SRS symbols 602, 604 are dropped.

FIG. 6b shows a plot 620 of collision handling behavior when SRS TD-OCC symbols and other UL signals overlap in time in the same cell according to a second option. The first plot 600 is identical to the plot 600 of FIG. 6a. The second plot 620 shows the second collision handling operation described above being applied. In this example, because the time overlap exists for the SRS symbols 604 and the PUSCH 606, only SRS symbols 604 are dropped. The SRS symbols 602 that do not overlap with the PUSCH 606 are transmitted.

In other exemplary embodiments, the network can configure and indicate the UE collision behavior based on the type of multiplexing used by the network. The network can smartly configure/indicate the UE and further UEs for collision handling to ensure SRS capacity.

In one option, the network can configure the UE to drop all SRS symbols when a partial overlap exists with another UL signal. The first option can be used, e.g., when inter-UE multiplexing is used at the network.

In another option, the network can allow the UE to keep partial SRS transmission when a partial overlap exists with another UL signal. The second option can be used, e.g., when only intra-UE multiplexing is used at the network.

In another aspect of these exemplary embodiments, the network can configure the SRS TD-OCC operation in the SRS configuration (SRS-Resource).

Within an SRS-Resource or SRS-PosResource configuration, the network can indicate parameters for OCC length N_{OCC} (parameter OCC-length), a selected OCC pattern (parameter OCC-Index) and a selected OCC hopping configuration (parameter OCC-hopping).

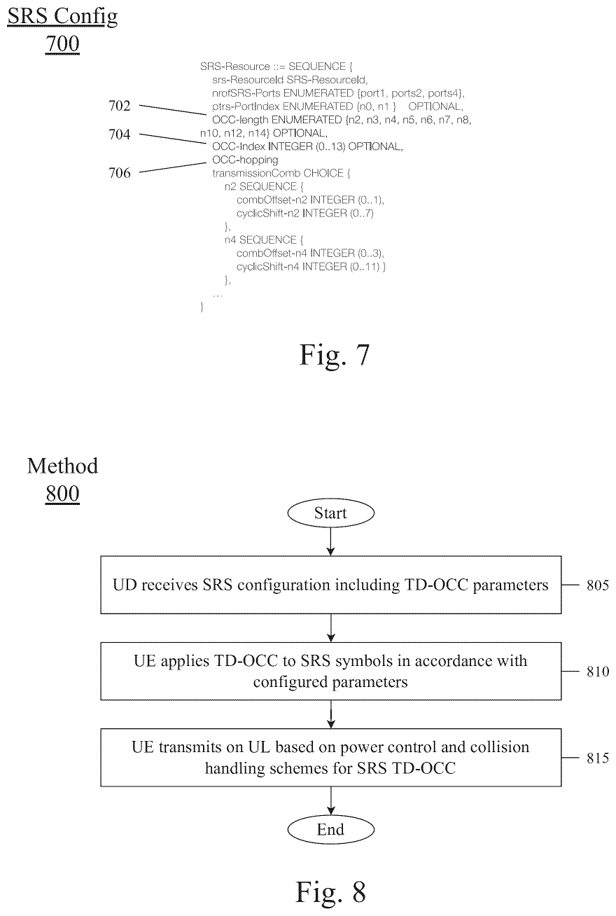

FIG. 7 shows an exemplary SRS Resource IE 700 including parameters for SRS TD-OCC according to various exemplary embodiments. The parameter 702 for OCC-length can indicate the length N_{OCC} of the OCC and can be selected from candidate values including, e.g., {2,3,4,5,6,7,8,10,11,12,14}. The parameter 704 for OCC-Index can indicate the selected OCC pattern with length N_{OCC}, wherein the value of OCC-Index is between 0 and N_{OCC}−1, inclusive. The parameter 706 for OCC-Hopping can indicate the OCC hopping configuration, wherein OCC hopping can be performed in the frequency domain and/or the time domain.

FIG. 8 shows a method 800 for using time domain orthogonal cover code (TD-OCC) for SRS capacity enhancement according to various exemplary embodiments.

In 805, the UE receives an SRS configuration (SRS-Resource) via RRC signaling. The SRS configuration can indicate parameters for frequency hopping, SRS sequence, a number Nₛ of OFDM symbols for the SRS resource, a repetition factor, and other parameters. According to the present embodiments, the SRS configuration can also include TD-OCC parameters including a length of the OCC (OCC-length), an OCC pattern (OCC-index), and an OCC hopping configuration (OCC-hopping). The length N_{OCC} of the TD-OCC code can be defined as a factor of the number of symbols for SRS repetition when intra-slot SRS frequency hopping is not configured. when intra-slot SRS frequency hopping is configured, N_{OCC} can be defined as a factor of the number of symbols for intra-slot SRS frequency hopping.

In some embodiments, the SRS sequence can be different for different SRS repetition symbols and/or different frequency hopping locations. The network can select different SRS sequences for different SRS repetition symbols and/or different frequency hopping locations to provide interference randomization. In other embodiments, different TD-OCC patterns can be used across different SRS frequency hopping locations to provide interference randomization.

In 810, the UE applies the TD-OCC to SRS symbols in accordance with the configured SRS parameters (e.g., length, pattern, hopping). The TD-OCC spreads the SRS across the time domain.

In 815, the UE transmits on the UL. The UE behavior for the UL transmission can depend on power control and collision handling schemes implemented by the UE and/or the RAN for the TD-OCC symbols.

For power control, in some embodiments, the UE maintains the same Tx power for all SRS symbols in an OCC operation (all SRS symbols within length N for TD-OCC) to ensure phase continuity. The UE ignores all power control commands received from the RAN for the SRS symbols with the exception of the first SRS symbol in the OCC operation. In other embodiments, the UE prioritizes the SRS symbols when scaling down of Tx power is needed. In still other embodiments, the UE scales down the Tx power of the SRS symbols when power scaling is needed, while ensuring phase continuity of the SRS symbols. In still other embodiments, the SRS symbols are dropped when phase continuity cannot be guaranteed.

For collision handling, in some embodiments, the UE drops some or all of the SRS symbols when the SRS symbols partially overlap with other UL PHY channels. In one option, partial SRS symbols not overlapping with the other PHY channels can be transmitted if the truncated TD-OCC applied to these SRS maintains orthogonality for the SRS symbols. In other embodiments, the network can configure the UE with collision handling behavior based on the operations of the network, e.g., whether inter-UE multiplexing is used or whether only intra-UE multiplexing is used.

### Examples

In a first example, a user equipment (UE) comprises a transceiver configured to communicate with a network and a processor communicatively coupled to the transceiver and configured to receive a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, apply the TD-OCC to the SRS resources in accordance with the configured parameters and perform uplink (UL) transmissions based on a power control scheme for SRS TD-OCC and a collision handling scheme for SRS TD-OCC.

In a second example, the UE of the first example, wherein the TD-OCC comprises Hadamard code or a discrete Fourier transform (DFT) sequence.

In a third example, the UE of the first example, wherein the SRS configuration includes different SRS sequence for different SRS repetition symbols in the SRS resource or different SRS frequency hopping locations in the SRS resource.

In a fourth example, the UE of the first example, wherein the SRS configuration includes different TD-OCC patterns for different frequency SRS hopping locations in the SRS resource.

In a fifth example, the UE of the first example, wherein the TD-OCC length for the TD-OCC pattern is defined as a factor of a number of symbols for SRS repetition when intra-slot SRS frequency hopping is not configured.

In a sixth example, the UE of the first example, wherein the TD-OCC length for the TD-OCC pattern is defined as a factor of a number of symbols for intra-slot SRS frequency hopping when intra-slot SRS frequency hopping is configured.

In a seventh example, the UE of the first example, wherein the power control scheme for SRS TD-OCC ensures that phase continuity is maintained for all SRS symbols within a SRS TD-OCC operation and a total UL transmit power remains within specified limits when other UL signals overlap in time with the SRS TD-OCC operation.

In an eighth example, the UE of the seventh example, wherein the UE transmits in the UL with all the SRS symbols within the SRS TD-OCC operation being transmitted at a same UL transmit power.

In a ninth example, the UE of the eighth example, wherein the processor of the UE is further configured to receive a first power control command for a first SRS symbol in the SRS TD-OCC operation and a second power control command for a second SRS symbol in the SRS TD-OCC operation later in time than the first SRS symbol, apply the first power control command to all the SRS symbols within the SRS TD-OCC operation and ignore the second power control command.

In a tenth example, the UE of the eighth example, wherein the processor of the UE is further configured to determine power scaling should be applied to reduce the total UL transmit power to within specified limits and reduce the UL transmit power of the UL signals overlapping in time with the SRS TD-OCC operation to bring the total UL transmit power to within the specified limits while maintaining the UL transmit power of the SRS symbols.

In an eleventh second example, the UE of the eighth example, wherein the processor of the UE is further configured to determine power scaling should be applied to reduce the total UL transmit power to within specified limits and increase or decrease the UL transmit power of the SRS symbols while ensuring the total UL transmit power is within the specified limits and phase continuity is maintained for the SRS symbols.

In a twelfth example, the UE of the first example, wherein, when phase continuity for the SRS symbols cannot be guaranteed, the SRS symbols are dropped by the UE.

In a thirteenth example, the UE of the first example, wherein, when the SRS TD-OCC operation overlaps in time with other UL signals in a same cell, the UE implements the collision handling scheme.

In a fourteenth example, the UE of the thirteenth example, wherein all of the SRS symbols are dropped when any of the SRS symbols in the TD-OCC operation overlap in time with the other UL symbols.

In a fifteenth example, the UE of the thirteenth example, wherein the SRS symbols in the TD-OCC operation that overlap in time with the other UL symbols are dropped and remaining SRS symbols in the TD-OCC operation that do not overlap in time with the other UL symbols are transmitted only when a truncated TD-OCC applied to the remaining SRS symbols maintain orthogonality.

In a sixteenth example, the UE of the thirteenth example, wherein the processor of the UE is further configured to receive a configuration for the collision handling scheme and either drop all of the SRS symbols in the TD-OCC operation when the SRS symbols partially overlap in time with the other UL symbols or drop only the SRS symbols in the TD-OCC operation that overlap in time with the other UL symbols based on the configuration for the collision handling scheme.

In a seventeenth example, the UE of the first example, wherein the TD-OCC parameters further include an OCC hopping configuration.

In an eighteenth example, a base station comprises a transceiver configured to communicate with a user equipment (UE) and a processor communicatively coupled to the transceiver and configured to determine a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, wherein the SRS configuration is applicable to the UE such that multiple UEs can use a same SRS resource and transmit the SRS configuration to the UE.

In a nineteenth example, the base station of the eighteenth example, wherein the TD-OCC comprises Hadamard code or a discrete Fourier transform (DFT) sequence.

In a twentieth example, the base station of the eighteenth example, wherein the SRS configuration includes different SRS sequence for different SRS repetition symbols in the SRS resource or different SRS frequency hopping locations in the SRS resource.

In a twenty first example, the base station of the eighteenth example, wherein the SRS configuration includes different TD-OCC patterns for different frequency SRS hopping locations in the SRS resource.

In a twenty second example, the base station of the eighteenth example, wherein the TD-OCC length for the TD-OCC pattern is defined as a factor of a number of symbols for SRS repetition when intra-slot SRS frequency hopping is not configured.

In a twenty third example, the base station of the eighteenth example, wherein the TD-OCC length for the TD-OCC pattern is defined as a factor of a number of symbols for intra-slot SRS frequency hopping when intra-slot SRS frequency hopping is configured.

In a twenty fourth example, the base station of the eighteenth example, wherein the processor of the base station is further configured to determine a configuration for a collision handling scheme by the UE, wherein the collision handling scheme comprises either dropping all of the SRS symbols in the TD-OCC operation when the SRS symbols partially overlap in time with other UL symbols or dropping only the SRS symbols in the TD-OCC operation that overlap in time with other UL symbols.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
process, based on signals received from a network, a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern;
apply the TD-OCC to the SRS resources in accordance with the configured parameters; and
perform uplink (UL) transmissions based on a power control scheme for SRS TD-OCC and a collision handling scheme for SRS TD-OCC.

2. The apparatus of claim 1, wherein the TD-OCC comprises Hadamard code or a discrete Fourier transform (DFT) sequence.

3. The apparatus of claim 1, wherein the SRS configuration includes different SRS sequence for different SRS repetition symbols in the SRS resource or different SRS frequency hopping locations in the SRS resource.

4. The apparatus of claim 1, wherein the SRS configuration includes different TD-OCC patterns for different frequency SRS hopping locations in the SRS resource.

5. The apparatus of claim 1, wherein the TD-OCC length for the TD-OCC pattern is defined as a factor of a number of symbols for SRS repetition when intra-slot SRS frequency hopping is not configured.

6. The apparatus of claim 1, wherein the TD-OCC length for the TD-OCC pattern is defined as a factor of a number of symbols for intra-slot SRS frequency hopping when intra-slot SRS frequency hopping is configured.

7. The processer apparatus of claim 1, wherein the power control scheme for SRS TD-OCC ensures that phase continuity is maintained for all SRS symbols within a SRS TD-OCC operation and a total UL transmit power remains within specified limits when other UL signals overlap in time with the SRS TD-OCC operation.

8. The processer apparatus of claim 7, wherein all the SRS symbols within the SRS TD-OCC operation are transmitted at a same UL transmit power.

9. The apparatus r of claim 8, wherein the processing circuitry is further configured to:
process, based on signals received from the network, a first power control command for a first SRS symbol in the SRS TD-OCC operation and a second power control command for a second SRS symbol in the SRS TD-OCC operation later in time than the first SRS symbol;
apply the first power control command to all the SRS symbols within the SRS TD-OCC operation; and
ignore the second power control command.

10. The apparatus of claim 8, wherein the processing circuitry is further configured to:
determine power scaling should be applied to reduce the total UL transmit power to within specified limits; and
reduce the UL transmit power of the UL signals overlapping in time with the SRS TD-OCC operation to bring the total UL transmit power to within the specified limits while maintaining the UL transmit power of the SRS symbols.

11. The apparatus of claim 8, wherein the processing circuitry is further configured to:
determine power scaling should be applied to reduce the total UL transmit power to within specified limits; and
increase or decrease the UL transmit power of the SRS symbols while ensuring the total UL transmit power is within the specified limits and phase continuity is maintained for the SRS symbols.

12. The apparatus of claim 1, wherein, when phase continuity for the SRS symbols cannot be guaranteed, the SRS symbols are dropped by the UE.

13. The apparatus of claim 1, wherein, when the SRS TD-OCC operation overlaps in time with other UL signals in a same cell, the collision handling scheme is implemented.

14. The apparatus of claim 13, wherein all of the SRS symbols are dropped when any of the SRS symbols in the TD-OCC operation overlap in time with the other UL symbols.

15. The apparatus of claim 13, wherein the SRS symbols in the TD-OCC operation that overlap in time with the other UL symbols are dropped and remaining SRS symbols in the TD-OCC operation that do not overlap in time with the other UL symbols are transmitted only when a truncated TD-OCC applied to the remaining SRS symbols maintain orthogonality.

16. The apparatus of claim 13, wherein the processing circuitry is further configured to:
process, based on signals received from the network, a configuration for the collision handling scheme; and
either drop all of the SRS symbols in the TD-OCC operation when the SRS symbols partially overlap in time with the other UL symbols or drop only the SRS symbols in the TD-OCC operation that overlap in time with the other UL symbols based on the configuration for the collision handling scheme.

17. The processer apparatus of claim 1, wherein the TD-OCC parameters further include an OCC hopping configuration.

18. An apparatus comprising processing circuitry configured to:
determine a sounding reference signal (SRS) configuration for SRS resources including time domain orthogonal cover code (TD-OCC) parameters for applying TD-OCC to the SRS resources, the TD-OCC parameters including a TD-OCC pattern and a TD-OCC length for the TD-OCC pattern, wherein the SRS configuration is applicable to a user equipment (UE) such that multiple UEs can use a same SRS resource; and
generate, for transmission to the UE, a message comprising the SRS configuration.

19. The processor of claim 18, wherein the TD-OCC comprises Hadamard code or a discrete Fourier transform (DFT) sequence.

20. The processor of claim 18, wherein the SRS configuration includes different SRS sequence for different SRS repetition symbols in the SRS resource or different SRS frequency hopping locations in the SRS resource.

21-24. (canceled)
